(19) United States
(12) Patent Application Publication
(10) Pub. No.: US 2024/0184005 A1
(43) Pub. Date: Jun. 6, 2024

(54) Elastic Wave Stress Tensor Double-Dot Product Seismic Imaging Method and Device

(71) Applicant: China University of Petroleum (East China), Qingdao City (CN)

(72) Inventors: Qizhen DU, Shandong Province (CN); Fuyuan ZHANG, Shandong Province (CN); Li-Yun FU, Shandong Province (CN)

(73) Assignee: China University of Petroleum (East China), Qingdao City (CN)

(21) Appl. No.: 18/492,288

(22) Filed: Oct. 23, 2023

(30) Foreign Application Priority Data
Oct. 21, 2022 (CN) 202211292308.9

(51) Int. Cl. G01V 1/30

(52) U.S. Cl. CPC G01V 1/307; G01V 2210/74

(57) ABSTRACT

The embodiment of the disclosure relates to an elastic wave stress tensor double-dot product seismic imaging method and device. The method comprises: obtaining a decoupled particle vibration velocity vector wave field by utilizing the existing decoupled wave equation method for the detected wave field; then obtaining a decoupled pseudo-stress wave field by constructing the decoupled pseudo-stress equation by using the obtained decoupled particle vibration velocity vector wave field; and finally computing a source second-order stress tensor wave field and the decoupled detected second-order stress tensor wave field by using the double-dot product cross-correlation imaging condition algorithm, to obtain the final scalar imaging results. With the embodiment of the present disclosure, the combined P-wave and S-wave stress exploration can be realized, therefore, the obtained imaging results can be used to accurately predict the risk of gas exploration.

### CROSS-REFERENCE TO RELATED APPLICATIONS

This application claims priority to Chinese Patent Application No. 202211292308.9, filed Oct. 21, 2022, which is hereby incorporated by reference in its entirety.

### TECHNICAL FIELD

The present disclosure relates to the field of exploration geophysics, in particular to an elastic wave stress tensor double-dot product seismic imaging method and device.

### BACKGROUND

In the current elastic reverse time migration imaging technology, the commonly used separation technique of structural decoupled wave equation can not obtain the shear wave stress without crosstalk. In addition, the stress field is essentially a second-order tensor, but the existing imaging conditions of scalar or vector correlation cannot be directly applied to the second-order stress tensor wavefield. The traditional stress imaging technology is mostly single P-wave component imaging technology, which cannot exert the advantage of combined P-wave and S-wave exploration, thereby resulting in poor imaging quality and an inability to accurately use the imaging results to predict the risks of oil and gas exploration.

There is an urgent need for an elastic wave stress tensor double-dot product seismic imaging method, so as to solve the problem that the existing P-wave imaging technology can not exert the advantages of combined P-wave and S-wave exploration, resulting in the inability to accurately use the multi-wave imaging results to predict the risks of oil and gas exploration.

### SUMMARY

In order to solve the above technical problems, the specific technical solutions of the embodiments in the present disclosure are as follows:

In one aspect, an embodiment of that present disclosure provides an elastic wave stress tensor double-dot product seismic imaging method, comprising:
based on a first order velocity-stress equation of an elastic isotropic medium, medium model parameters, a function of source wavelet and multi-component seismic records are taken as inputs, to solve the first order velocity-stress equation of an elastic isotropic medium by a staggered grid high-order finite difference method, thereby obtaining a source stress tensor wave field and a detected particle vibration velocity vector wave field;
constructing a decoupled wave equation by using the detected particle vibration velocity vector wave field to obtain a decoupled detected longitudinal wave particle vibration velocity vector wave field and a decoupled detected transverse wave particle vibration velocity vector wave field;
constructing a decoupled pseudo-stress equation by using the decoupled detected longitudinal wave particle vibration velocity vector wave field and the decoupled detected transverse wave particle vibration velocity vector wave field to obtain a detected decoupled pseudo-stress tensor wave field;
the source stress tensor wave field and the detected decoupled pseudo-stress tensor wave field are calculated by using a double-dot product cross-correlation imaging condition algorithm to obtain a pseudo PP scalar imaging result and a pseudo PS scalar imaging result, and taking the pseudo PP scalar imaging result and the pseudo PS scalar imaging result as elastic wave stress tensor double-dot product seismic imaging results.

In another aspect, the embodiment of the present disclosure further provides a computer device comprising a memory, a processor and a computer program stored on the memory, the processor implementing the method described above when executing the computer program.

In another aspect, the embodiment of the present disclosure further provides a computer storage medium storing a computer program therein, that, when run by a processor of a computer device, performs the method described above.

In the embodiment of the specification, by utilizing the existing decoupled wave equation method to calculate the detected wave field, the decoupled particle vibration velocity vector wave field is obtained, then use the obtained decoupled particle vibration velocity vector wave field to construct a decoupled pseudo-stress equation, calculate the decoupled pseudo-stress equation to obtain a decoupled pseudo-stress wave field, and finally a source second-order stress tensor wave field and the decoupled detected second-order stress tensor wave field are computed by using the double-dot product cross-correlation imaging condition algorithm, to obtain the final scalar imaging results. In the embodiment of the present specification, the stress imaging results include both the P-wave stress imaging result and the S-wave stress imaging result, so that the combined P-wave and S-wave stress exploration can be realized, therefore, the obtained imaging results can be used to accurately predict the risk of gas exploration, so as to solve the problem that the existing P-wave imaging technology can not exert the advantage of combined P-wave and S-wave exploration, resulting in the inability to accurately use the multi-wave imaging results to predict the risks of oil and gas exploration.

### BRIEF DESCRIPTION OF DRAWINGS

In order to more clearly explain the embodiment of the present disclosure or the technical solution in the prior art, the accompanying drawings used in the description of the embodiment or the prior art will be briefly described below.

FIG. 1 is a flow schematic diagram of an elastic wave stress tensor double-dot product seismic imaging method according to an embodiment of the present specification;

FIGS. 2a and 2b are schematic diagrams illustrating the definition of a staggered grid according to an embodiment of the present specification;

FIG. 3 is a schematic diagram of specific parameters of a horizontal-vertical interface elastic model according to an embodiment of the present disclosure;

FIGS. 4a, 4b and 4c show wave field snapshots at 450 ms for forward decoupling of the P-wave pseudo stress of the model shown in FIGS. 2a and 2b according to an embodiment of the present specification;

FIGS. 5a, 5b and 5c show wave field snapshots at 450 ms for forward decoupling of the S-wave pseudo stress of the model shown in FIGS. 2a and 2b according to an embodiment of the present specification;

FIGS. 6a, 6b and 6c show the Marmousi2 model after resampling according to the embodiment of the present specification;

FIGS. 7a and 7b show the results of offset imaging shown in FIGS. 5a, 5b and 5c according to an embodiment of the present specification;

FIGS. 8a, 8b and 8c show respectively images obtained by enlarging the width of the Marmousi2 model in FIGS. 6a, 6b and 6c from 1000 m to 3200 m and the depth from 1100 m to 1600 m according to an embodiment of the present disclosure;

FIGS. 9a and 9b show results of offset imaging of the region shown in FIGS. 8a and 8b using the method of the embodiment of the present disclosure according to the embodiment of the present specification;

FIG. 10 is a structural schematic diagram of an elastic wave stress tensor double-dot product seismic imaging device according to an embodiment of the present specification;

FIG. 11 is a structural schematic diagram of a computer device according to an embodiment of the present specification.

### DESCRIPTION OF THE REFERENCE NUMERALS

1001. first order velocity-stress equation solving unit;

1002. decoupled wave equation solving unit;

1003. decoupled pseudo-stress equation solving unit;

1004. imaging result computing unit;

1102. computer device;

1104. processing device;

1106. memory resource;

1108. driving mechanism;

1110. input/output module;

1112. input device;

1114. output device;

1116. presentation device;

1118. graphical user interface;

1120. network interface;

1122. communication link;

1124. communication bus.

### DETAILED DESCRIPTION

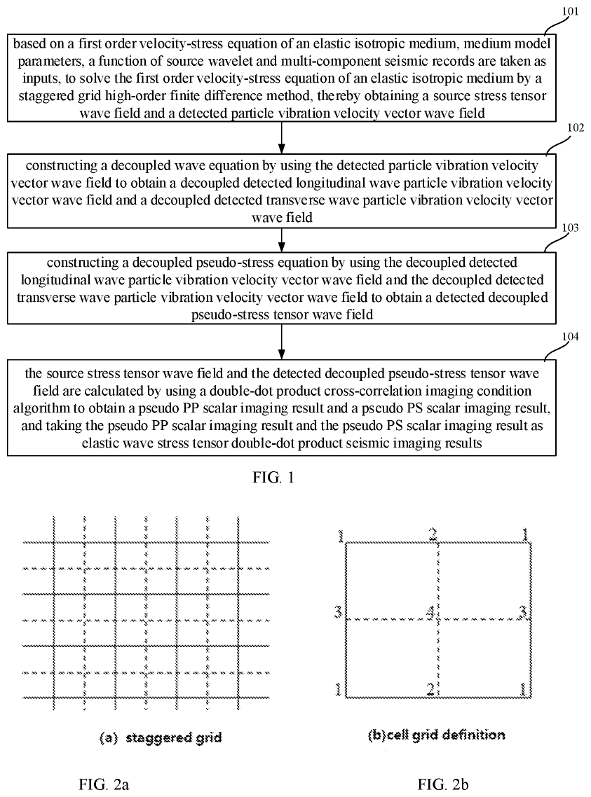

In order to solve the problems existing in the prior art, an embodiment of that present disclosure provides an elastic wave stress tensor double-dot product seismic imaging method, which can obtain a decoupled stress wave field, and in the corresponding imaging conditions, each part of the energy in the stress tensor wave field is taken into account, and the scalar imaging results can be obtained by a relatively simple calculation procedure. FIG. 1 is a flow schematic diagram of an elastic wave stress tensor double-dot product seismic imaging method according to an embodiment of the present specification. The process of imaging based on seismic stress is described in this figure. Specifically, as shown in FIG. 1, the method can be executed by a processor, and may comprise:
a step 101: based on a first order velocity-stress equation of an elastic isotropic medium, medium model parameters, a function of source wavelet and multi-component seismic records are taken as inputs, to solve the first order velocity-stress equation of an elastic isotropic medium by a staggered grid high-order finite difference method, thereby obtaining a source stress tensor wave field and a detected particle vibration velocity vector wave field;
a step 102: constructing a decoupled wave equation by using the detected particle vibration velocity vector wave field to obtain a decoupled detected longitudinal wave particle vibration velocity vector wave field and a decoupled detected transverse wave particle vibration velocity vector wave field;
a step 103: constructing a decoupled pseudo-stress equation by using the decoupled detected longitudinal wave particle vibration velocity vector wave field and the decoupled detected transverse wave particle vibration velocity vector wave field to obtain a detected decoupled pseudo-stress tensor wave field;
a step 104: the source stress tensor wave field and the detected decoupled pseudo-stress tensor wave field are calculated by using a double-dot product cross-correlation imaging condition algorithm to obtain a pseudo PP scalar imaging result and a pseudo PS scalar imaging result, and taking the pseudo PP scalar imaging result and the pseudo PS scalar imaging result as elastic wave stress tensor double-dot product seismic imaging results.

In the embodiment of the specification, by utilizing the existing decoupled wave equation method to calculate the detected wave field, the decoupled particle vibration velocity vector wave field is obtained, then use the obtained decoupled particle vibration velocity vector wave field to construct a decoupled pseudo-stress equation, calculate the decoupled pseudo-stress equation to obtain a decoupled pseudo-stress wave field, and finally a source second-order stress tensor wave field and the decoupled detected second-order stress tensor wave field are computed by using the double-dot product cross-correlation imaging condition algorithm, to obtain the final scalar imaging results. In the embodiment of the present specification, the stress imaging results include both the P-wave stress imaging result and the S-wave stress imaging result, so that the combined P-wave and S-wave stress exploration can be realized, therefore, the obtained imaging results can be used to accurately predict the risk of gas exploration, so as to solve the problem that the existing P-wave imaging technology can not exert the advantage of combined P-wave and S-wave exploration, resulting in the inability to accurately use the multi-wave imaging results to predict the risks of oil and gas exploration.

The elastic wave stress tensor double-dot product seismic imaging method described in the embodiment of the present disclosure comprises:
Step 1: based on a first order velocity-stress equation of an elastic isotropic medium, medium model parameters, a source function of wavelet and multi-component seismic records are taken as inputs, to solve the first order velocity-stress equation by a staggered grid high-order finite difference method, thereby obtaining a source stress tensor wave field and a detected particle vibration velocity vector wave field;
the first order velocity-stress equation of an elastic isotropic medium is given by the formula (1):

$$\{ \begin{matrix}\frac{\partial {τ}_{xx}}{\partial t} = ( λ + 2 μ ) \frac{\partial {v}_{x}}{\partial x} + λ \frac{\partial {v}_{z}}{\partial z} \\ \frac{\partial {τ}_{zz}}{\partial t} = λ \frac{\partial {v}_{x}}{\partial x} + ( λ + 2 μ ) \frac{\partial {v}_{z}}{\partial z} \\ \frac{\partial {τ}_{xz}}{\partial t} = μ \frac{\partial {v}_{z}}{\partial x} + μ \frac{\partial {v}_{x}}{\partial z} \\ ρ \frac{\partial {v}_{x}}{\partial t} = \frac{\partial {τ}_{xx}}{\partial x} + \frac{\partial {τ}_{xz}}{\partial z} \\ ρ \frac{\partial {v}_{z}}{\partial t} = \frac{\partial {τ}_{xz}}{\partial x} + \frac{\partial {τ}_{zz}}{\partial z}\end{matrix} \qquad ( 1 )$$

wherein (τₓₓ, τ_{zz}, τ_{xz}) denotes the source stress tensor wave field, (vₓ, v_{z}) denotes the detected particle vibration velocity vector wave field, λ and μ denote Lame's parameters, ρ denotes density; t denotes time; x and z denote x and z directions of a two-dimensional Cartesian coordinate system respectively;
the definition of the staggered grid is shown in FIGS. 2a and 2b, FIG. 2a is a schematic diagram of the entire spatial grid, FIG. 2b shows cell grid definition, in which the full grid is represented by solid lines and the half grid by dashed lines, and the source stress tensor wave field (τₓₓ, τ_{zz}, τ_{xz}) and the detected particle vibration velocity vector wave field are defined according to the four different spatial relative positions 1, 2, 3 and 4 in FIG. 2b, as shown in the formula (2):

(1:vₓ; 2:(τₓₓ, τ_{zz}; 3:τ_{xz}; 4:v_{z}) (2)

Based on the above definition of the grid points, the staggered grid high-order finite difference method is used to discretize the first order velocity-stress equation of an elastic isotropic medium, and a discrete scheme is given as formula (3):

$${v}_{{x}_{i + \frac{1}{2} , k}}^{n + \frac{1}{2}} = {v}_{{x}_{i + \frac{1}{2} , k}}^{n - \frac{1}{2}} + {ρ}^{- 1} \cdot Δ t \cdot {F}_{x} {τ}_{{xx}_{i , k}}^{n} + {ρ}^{- 1} \cdot Δ t \cdot {B}_{z} {τ}_{{xz}_{i + \frac{1}{2} , k + \frac{1}{2}}}^{n} \\ {v}_{{z}_{i , k + \frac{1}{2}}}^{n + \frac{1}{2}} = {v}_{{z}_{i , k + \frac{1}{2}}}^{n - \frac{1}{2}} + {ρ}^{- 1} \cdot Δ t \cdot {B}_{x} {τ}_{{xz}_{i + \frac{1}{2} , k + 12}}^{n} + {ρ}^{- 1} \cdot Δ t \cdot {F}_{x} {τ}_{{zz}_{i , k}}^{n} \\ {τ}_{{xx}_{i , k}}^{n} = {τ}_{{xx}_{i , k}}^{n - 1} + Δ t ( λ + 2 μ ) {B}_{x} {v}_{{x}_{i + \frac{1}{2} , k}}^{n + \frac{1}{2}} + Δ t λ {B}_{z} {v}_{{z}_{i , k + \frac{1}{2}}}^{n + \frac{1}{2}} \\ {τ}_{{zz}_{i , k}}^{n} = {τ}_{{zz}_{i , k}}^{n - 1} + Δ t \cdot λ \cdot {B}_{x} {v}_{{x}_{i + \frac{1}{2} , k}}^{n + \frac{1}{2}} + Δ t \cdot ( λ + 2 μ ) {B}_{z} {v}_{{z}_{i , k + \frac{1}{2}}}^{n + \frac{1}{2}} \\ {τ}_{{xz}_{i + \frac{1}{2} , k + \frac{1}{2}}}^{n} = {τ}_{{xz}_{i + \frac{1}{2} , k + \frac{1}{2}}}^{n - 1} + Δ t \cdot μ {F}_{x} {v}_{{z}_{i , k + \frac{1}{2}}}^{n + \frac{1}{2}} + Δ t \cdot μ {F}_{z} {v}_{{x}_{i + \frac{1}{2} , k}}^{n + \frac{1}{2}} \qquad ( 3 )$$

in the discretization format, Δt denotes time interval, i and k denote discrete points in the x and z directions in the two-dimensional Cartesian coordinate system respectively, n denotes discrete point in the direction of time t, ρ⁻¹ denotes the −1 power of the density ρ, Fₛ(s=x, z) and Bₛ(s=x, z) denote a forward difference operator and a backward difference operator in x, z directions respectively, and the specific expression is formula (4):

$${F}_{x} {f}_{i , k} = \frac{1}{Δ x} {\sum }_{m = 1}^{M} {c}_{m}^{( M )} [ {f}_{i + m , k} - {f}_{i - m + 1 , k} ] , \\ {B}_{x} {f}_{i , k} = \frac{1}{Δ x} {\sum }_{m = 1}^{M} {c}_{m}^{( M )} [ {f}_{i + m - 1 , k} - {f}_{i - m , k} ] , \\ {F}_{z} {f}_{i , k} = \frac{1}{Δ z} {\sum }_{m = 1}^{M} {c}_{m}^{( M )} [ {f}_{i , k + m} - {f}_{i , k - m + 1} ] , \\ {B}_{z} {f}_{i , k} = \frac{1}{Δ z} {\sum }_{m = 1}^{M} {c}_{m}^{( M )} [ {f}_{i , k + m - 1} - {f}_{i , k - m} ] . \qquad ( 4 )$$

wherein Δx and Δz denote sampling intervals in x and z directions respectively, f_{i,k} denotes a wave field quantity acted by difference operator, i and k denote the discrete points and are used for determining the spatial location of the wave field quantity, Cₘ^{(M)} denotes finite difference coefficients of the 2 M -order staggered grid, 2 M denotes difference order, and Mdenotes a positive integer;
the Lame's parameters λ and μ, and the density ρ are obtained according to the given medium model parameters by using the above discrete scheme; during extension process of a source wave field, the P-wave source in the form of a Ricker wavelet is loaded on (τₓₓ, τ_{zz}) of the source stress tensor wave field in the formula (3), the particle vibration velocity component (vₓ, v_{z}) and the particle stress tensor wave field (τₓₓ, τ_{zz}, τ_{xz}) in the formula (3) are iteratively updated, and the source stress tensor wave field (τₓₓ, τ_{zz}, τ_{xz}) is obtained by calculation; during extension process of the detected wave field, multi-component seismic records is loaded on the detected particle vibration velocity vector wave field (vₓ, v_{z}), and the particle stress tensor wave field (τₓₓ, τ_{zz}, τ_{xz}) and the particle vibration velocity component (vₓ, v_{z}) in the formula (3) are iteratively updated, and the detected particle vibration velocity vector wave field (vₓ, v_{z}) is obtained by calculation.
Step 2: using the detected particle vibration velocity vector wave field (vₓ, v_{z}) to construct the auxiliary P-wave stress as shown in the formula (5):

$$\frac{\partial {τ}^{P}}{\partial t} = ( λ2μ ) ( \frac{\partial {v}_{x}}{\partial x} + \frac{\partial {v}_{z}}{\partial z} ) \qquad ( 5 )$$

wherein τ^{P} denotes the auxiliary P-wave stress. By solving the formula (5), the decoupled detected longitudinal wave particle vibration velocity vector wave field and the decoupled detected transverse wave particle vibration velocity vector wave field can be obtained.
Wherein, the decoupled detected longitudinal wave particle vibration velocity vector wave field is represented by formula (6):

$$\{ \begin{matrix}ρ \frac{\partial {v}_{x}^{P}}{\partial t} = \frac{\partial {τ}^{P}}{\partial x} \\ ρ \frac{\partial {v}_{z}^{P}}{\partial t} = \frac{\partial {τ}^{P}}{\partial z}\end{matrix} \qquad ( 6 )$$

Wherein, (vₓ^{P}, v_{z}^{P}) denotes the decoupled detected longitudinal wave particle vibration velocity vector wave field;
the decoupled detected transverse wave particle vibration velocity vector wave field is represented by formula (7):

$$\{ \begin{matrix}{v}_{x}^{S} = {v}_{x} - {v}_{x}^{P} \\ {v}_{z}^{S} = {v}_{z} - {v}_{z}^{P}\end{matrix} \qquad ( 7 )$$

Wherein, (vₓ^{S}, v_{z}^{S}) denotes the decoupled detected transverse wave particle vibration velocity vector wave field.
Step 3: constructing a decoupled pseudo-stress equation by using the decoupled detected longitudinal wave particle vibration velocity vector wave field and the decoupled detected transverse wave particle vibration velocity vector wave field to obtain a detected decoupled pseudo-stress tensor wave field;
the longitudinal wave pseudo-stress equation is given by the formula (8):

$$\frac{\partial {τ}_{qp , ij}}{\partial t} = λ {v}_{k , k}^{P} {δ}_{ij} + 2 μ {v}_{i , j}^{P} \qquad ( 8 )$$

Equation (8) is expanded into equation (9):

$$\{ \begin{matrix}\frac{\partial {τ}_{xx}^{qP}}{\partial t} = ( λ + 2 μ ) ( \frac{\partial {v}_{x}^{P}}{\partial x} + \frac{\partial {v}_{x}^{P}}{\partial z} ) - 2 μ \frac{\partial {v}_{z}^{P}}{\partial z} \\ \frac{\partial {τ}_{zz}^{qP}}{\partial t} = ( λ + 2 μ ) ( \frac{\partial {v}_{x}^{P}}{\partial x} + \frac{\partial {v}_{x}^{P}}{\partial z} ) - 2 μ \frac{\partial {v}_{x}^{P}}{\partial x} \\ \frac{\partial {τ}_{xz}^{qP}}{\partial t} = μ ( \frac{\partial {v}_{x}^{P}}{\partial z} + \frac{\partial {v}_{z}^{P}}{\partial x} )\end{matrix} \qquad ( 9 )$$

the transverse wave pseudo-stress equation is given by the formula (10):

$$\frac{\partial {τ}_{qs , ij}}{\partial t} = 2 μ {v}_{i , j}^{S} \qquad ( 10 )$$

Equation (10) is expanded into equation (11):

$$\{ \begin{matrix}\frac{\partial {τ}_{xx}^{qS}}{\partial t} = - 2 μ \frac{\partial {v}_{z}^{S}}{\partial z} \\ \frac{\partial {τ}_{zz}^{qS}}{\partial t} = - 2 μ \frac{\partial {v}_{z}^{S}}{\partial x} \\ \frac{\partial {τ}_{xz}^{qS}}{\partial t} = μ ( \frac{\partial {v}_{x}^{S}}{\partial z} + \frac{\partial {v}_{z}^{S}}{\partial x} )\end{matrix} \qquad ( 11 )$$

In the formulas (8) to (11), (τₓₓ^{qP}, τ_{zz}^{qP}, τ_{xz}^{qP}) denotes the longitudinal wave pseudo stress, (τₓₓ^{qS}, τ_{zz}^{qS}, τ_{xz}^{qS}) denotes the transverse wave pseudo stress, denotes Kronecker function.

The decoupled detected longitudinal wave particle vibration velocity vector wave field (vₓ^{P}, v_{z}^{P}) and the decoupled detected transverse wave particle vibration velocity vector wave field (vₓ^{S}, v_{z}^{S}) are substituted into the longitudinal wave pseudo-stress equation and the transverse wave pseudo-stress equation respectively to obtain the detected decoupled pseudo-stress tensor wave field Rcv, wherein the detected decoupled pseudo-stress tensor wave field includes a detected longitudinal wave decoupled pseudo-stress tensor wave field Rcv^{P}=τₓₓ^{qP}, τ_{zz}^{qP}, τ_{xz}^{qP}) and a detected transverse wave decoupled pseudo-stress tensor wave field Rcv^{S}=(τₓₓ^{qS}, τ_{zz}^{qS}, τ_{xz}^{qS})
Step 4: the source stress tensor wave field Src=(τₓₓ, τ_{zz}, τ_{xz}) and the detected decoupled pseudo-stress tensor wave field Rcv are calculated by using a double-dot product cross-correlation imaging condition algorithm, as shown in the formula (12):

$$\{ \begin{matrix}{I}_{qPP} = {\int }_{0}^{{t}_{max}} Src ( x , t ) : {Rcv}^{P} ( x , t ) dt \\ {I}_{qPS} = {\int }_{0}^{{t}_{max}} Src ( x , t ) : {Rcv}^{S} ( x , t ) dt\end{matrix} \qquad ( 12 )$$

wherein I_{qPP} denotes the pseudo PP scalar imaging result, I_{qPS} denotes the pseudo PS scalar imaging result, the position vector x denotes spatial position coordinates (x, z) of the calculation node in the two-dimensional Cartesian coordinate system, t denotes time, : denotes the double-dot product operation symbol; the operation is expanded using the double-dot product algorithm as shown in the formula (13):

$$\{ \begin{matrix}{I}_{qPP} = {\int }_{0}^{{t}_{max}} ( {Src}_{{σ}_{xx}} ( x , t ) {Rcv}_{{τ}_{xx}^{qP}}^{P} ( x , t ) + {Src}_{{σ}_{zz}} ( x , t ) {Rcv}_{{τ}_{zz}^{qP}}^{P} ( x , t ) + 2 {Src}_{{σ}_{xz}} ( x , t ) {Rcv}_{{τ}_{xz}^{qP}}^{P} ( x , t ) ) dt \\ {I}_{qPS} = {\int }_{0}^{{t}_{max}} ( {Src}_{{σ}_{xx}} ( x , t ) {Rcv}_{{τ}_{xx}^{qS}}^{S} ( x , t ) + {Src}_{{σ}_{zz}} ( x , t ) {Rcv}_{{τ}_{zz}^{qS}}^{S} ( x , t ) + 2 {Src}_{{σ}_{xz}} ( x , t ) {Rcv}_{{τ}_{xz}^{qS}}^{S} ( x , t ) ) dt\end{matrix} \qquad ( 13 )$$

wherein Src and Rcv denote corresponding component forms of the source stress tensor wave field Src and the detected decoupled pseudo-stress tensor wave field Rcv respectively, Src_{π}_{ₓₓ}, Src_{π}_{_{zz}}, Src_{π}_{_{xz}}, denote xx, zz, xz components of the source stress tensor respectively,

$${Rcv}_{{τ}_{xx}^{qP}}^{P} , {Rcv}_{{τ}_{zz}^{qP}}^{P} , {Rcv}_{{τ}_{xz}^{qP}}^{P}$$

denote xx, zz, xz components of the detected decoupled longitudinal wave pseudo stress tensor respectively,

$${Rcv}_{{τ}_{xx}^{qS}}^{S} , {Rcv}_{{τ}_{zz}^{qS}}^{S} , {Rcv}_{{τ}_{xz}^{qS}}^{S}$$

denote xx, zz, xz components of the detected decoupled transverse wave pseudo stress tensor respectively. The pseudo PP scalar imaging result I_{qPP} and the pseudo PS scalar imaging result I_{qPS} are taken as the elastic wave stress tensor double-dot product seismic imaging results. It should be noted that the pseudo PP imaging result I_{qPP} and the pseudo PS imaging result I_{qPS} are different from the conventional PP and PS imaging results, which is mainly represented in that the conventional imaging results mostly utilize the particle vibration velocity vector or the displacement field for imaging, and I_{qPP} and I_{qPS} use the elastic stress wave field satisfying the tensor form to perform imaging.

In the embodiment of the specification, a second-order tensor decoupled stress wave field corresponding to the total stress wave field can be obtained, the second-order stress tensor wave field can be directly used to obtain the scalar imaging result by using the double-dot product cross-correlation imaging condition, and the physical meaning is more definite, and the imaging condition fully considers each component of tensor wave field, and realizes the stress imaging of elastic reverse time migration, which provides an additional choice for elastic reverse time migration algorithm.

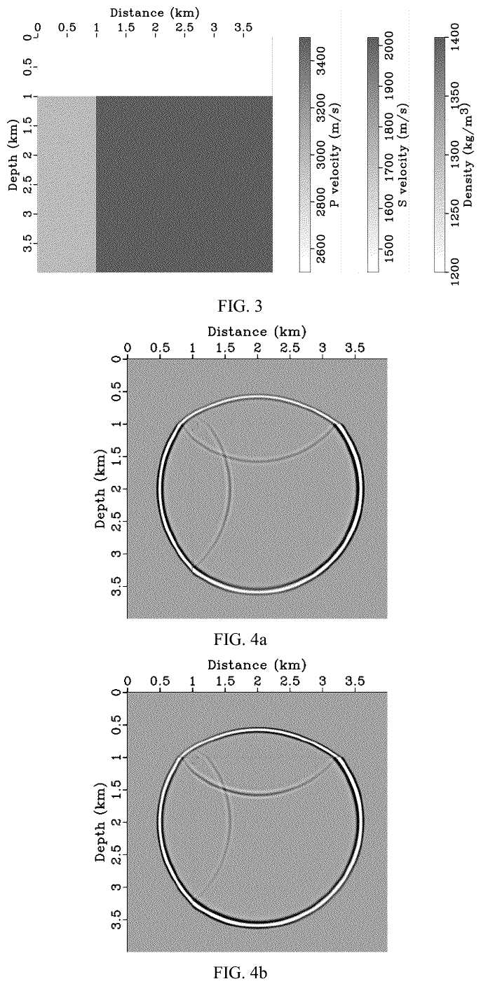

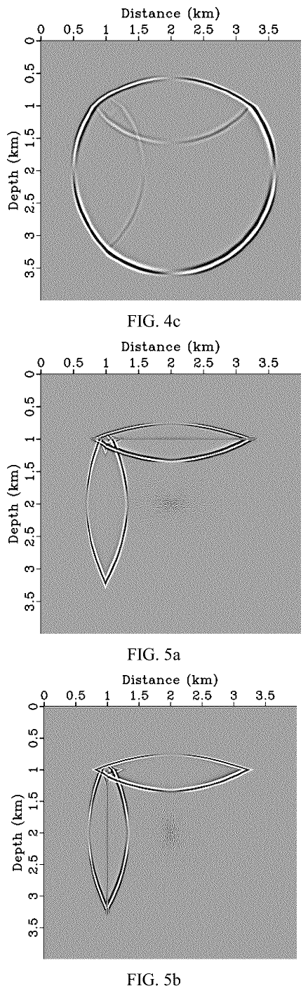

Illustratively, an disclosure of the stress wave field decoupling method of an elastic model having a horizontal-vertical interface is described in connection with an embodiment of the present specification, the model and its parameters are shown in FIG. 3, in which the abscissa “Distance” denotes the model width, the ordinate “Depth” denotes the model depth in the unit of km, a, b and c in FIG. 3 denote the longitudinal wave velocity, the transverse wave velocity, and the density respectively. The wave field is simulated by using pure P wave excited by a 30 Hz dominant frequency Ricker wavelet source function as an input, and the detected particle vibration velocity vector wave field is obtained by applying step 1 of the embodiment of the specification, then the decoupled detected longitudinal wave particle vibration velocity vector wave field and the decoupled detected transverse wave particle vibration velocity vector wave field are obtained by applying the decoupled wave equation in the step 2 in the embodiment of the present specification, and next the decoupled P-wave and S-wave pseudo stresses are obtained by applying the pseudo-stress decoupled equation in the step 3 of the embodiment of the present specification, and the results of the decoupled detected longitudinal wave pseudo stress are shown in FIGS. 4a, 4b and 4c, the results of the decoupled detected transverse wave pseudo stress are shown in FIGS. 5a, 5b and 5c. In FIGS. 4a, 4b, 4c and FIGS. 5a, 5b and 5c, the abscissa “Distance” denotes the model width, and the ordinate “Depth” denotes the model depth in the unit of km. It can be seen from FIGS. 4a, 4b, 4c and 5a, 5b, 5c that the transmission, reflection P-wave and conversion transmission, conversion reflection S-wave are decoupled successfully at the interface, therefore, it can be shown that the stress decoupling method of the embodiment in this disclosure is correct and effective.

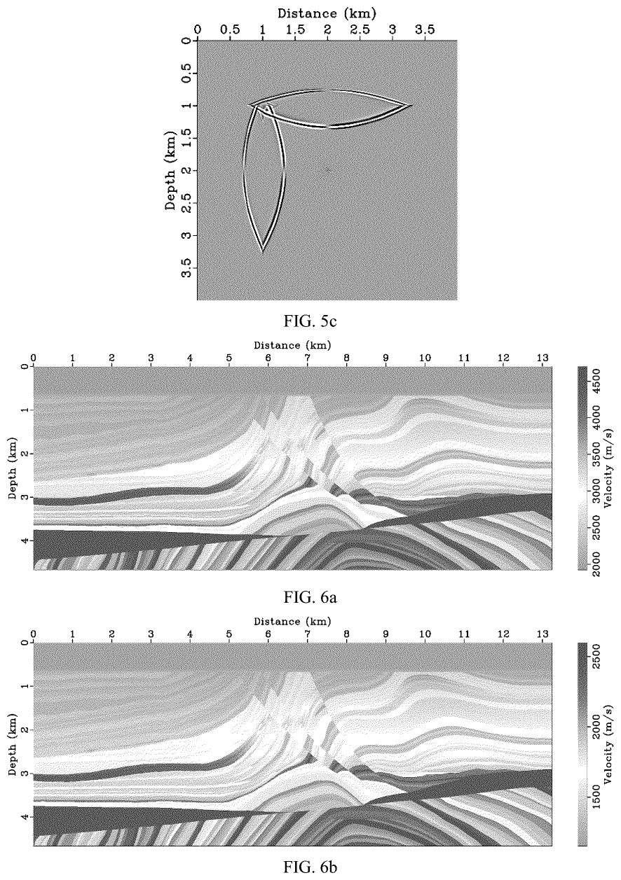

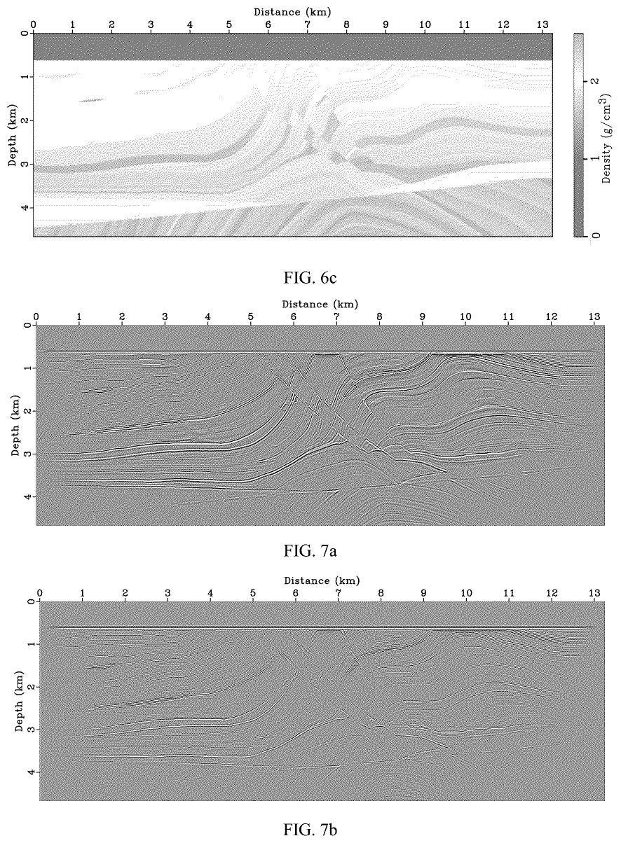

In order to verify the applicability of the double-dot product cross-correlation imaging condition method of the embodiment of the disclosure in a complex model, the stress decoupling and imaging conditions of the embodiment of this disclosure are used in the elastic wave imaging experiment of the Marmousi2 model after resampling, and the model speed is shown in FIGS. 6a, 6b and 6c, in which FIG. 6a shows the Marmousi2 model longitudinal wave velocity model, FIG. 6b shows the Marmousi2 model longitudinal wave velocity model, FIG. 6c shows a transverse wave velocity model and a density model.

Hereinafter, a certain shot imaging is taken as an example to explain the migration imaging process by applying the embodiment of the specification.

The source wave field is extrapolated forward with the source function as the input, and the detected wave field is extrapolated backward with the unseparated multi-component seismic data as the input to obtain the elastic wave field at each time. For the detected wave field, the detected particle vibration velocity vector wave field is obtained by applying step 1 of the embodiment of the specification, then the decoupled detected longitudinal wave particle vibration velocity vector wave field and the decoupled detected transverse wave particle vibration velocity vector wave field are obtained by applying the decoupled wave equation in the step 2 in the embodiment of the present specification; and next the decoupled P-wave and S-wave pseudo stresses are obtained by applying the pseudo-stress decoupled equation in the step 3 of the embodiment of the present specification; in combination with the source stress wave field and the detected decoupled pseudo stress wave field, the double-dot product cross-correlation imaging condition in the step 4 is applied to obtain the scalar imaging result. A single shot imaging result is obtained by applying the above procedure, and the final multi-shot stacking result is as shown in FIGS. 7a and 7b, in which FIG. 7a denotes the scalar pseudo PP imaging result I_{qPP}, FIG. 7b denotes the scalar pseudo PS imaging result I_{qPS}. Compared with the models in FIGS. 6a, 6b and 6c, the imaging results well image the structure, stratum, depth and other information of the models, which shows that the double-dot product cross-correlation imaging condition of the embodiment in this disclosure can be applied to the elastic reverse-time migration stress imaging of complex media.

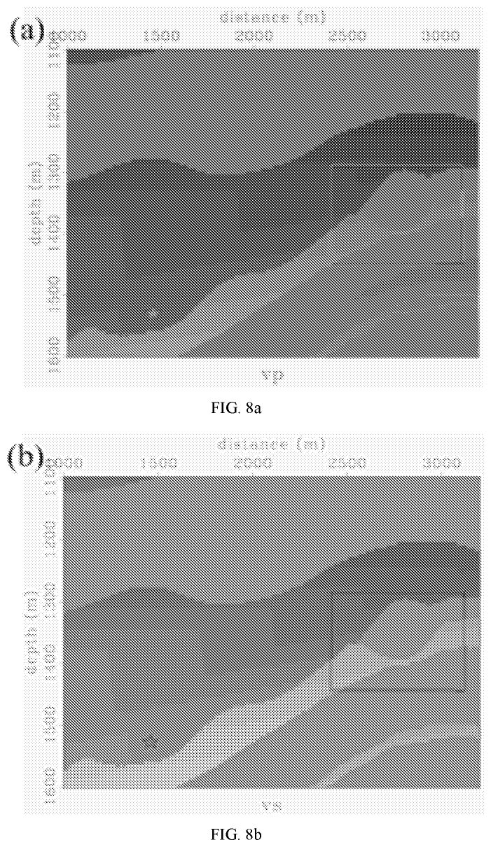

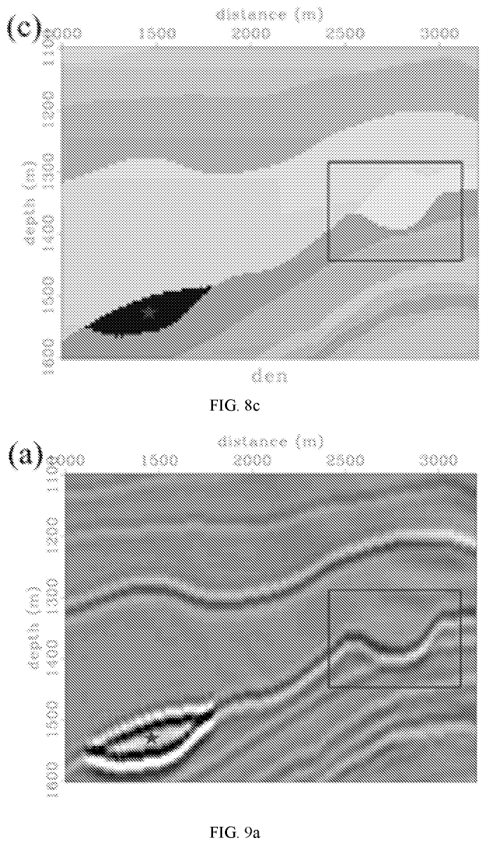

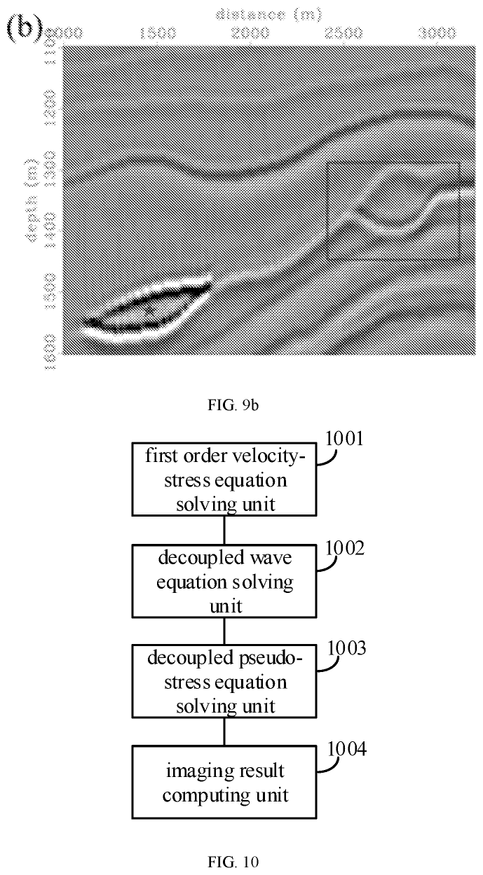

Furthermore, in order to illustrate the advantage of this method in the explanation of seismic exploration for oil and gas, the Marmousi2 model is enlarged at a width of 1000 m˜3200 m and a depth of 1100 m˜1600 m, as shown in FIGS. 8a, 8b and 8c, in which FIG. 8a shows the P-wave velocity model of this portion, FIG. 8b shows the S-wave velocity model of this portion, and FIG. 8c shows the density model of this portion. From the enlarged model, it can be seen that there is a special lithologic region (pentagram position) in this region, and there is no difference in P-S wave velocity and obvious difference in density in this special lithologic region. In addition, there is a “lens body” configuration in this region (box circled in FIGS. 7a and 7b). In oil and gas exploration, the lenticular structure is usually a favorable location for oil and gas accumulation, and is also one of the key targets of exploration. The enlarged portion of the imaging result is enlarged as shown in FIGS. 9a and 9b, in which FIG. 9a shows the scalar pseudo PP imaging result/q of the region, FIG. 9b shows the scalar pseudo PS imaging result/gps of the region. From the imaging results in FIGS. 9a and 9b, it can be seen that very clear images are obtained at the top and bottom interfaces I_{qPP} and I_{qPS} of special lithologic regions (at the five-pointed star positions in FIGS. 9a and 9b). However, the imaging result at the top interface I_{qPP} of the lens body are very blurred, and the outline of the top interface of the “lens body” is basically not seen (box circled in FIG. 9a), this will increase the risk of actual oil and gas exploration, and is also the traditional single-component seismic exploration problems, while in FIG. 9b, the I_{qPS} imaging result provides a clear characterization of the top interface of the “lens body”, which is very important for oil and gas exploration stage or subsequent interpretation, development and calculation of reserves. Therefore, the method of the embodiment of the present disclosure can be used in the joint interpretation of seismic exploration imaging, and has the potential to reduce the risk of oil and gas exploration.

Based on the same inventive concept, the embodiment of the disclosure also provides an elastic wave stress tensor double-dot product seismic imaging device, for executing the elastic wave stress tensor double-dot product seismic imaging method as described in the embodiment of the specification. Specifically, the elastic wave stress tensor double-dot product seismic imaging device of the embodiment of the present disclosure is divided into a plurality of units according to functional modules, as shown in FIG. 10, comprising:
a first order velocity-stress equation solving unit 1001, in which based on a first order velocity-stress equation of an elastic isotropic medium, medium model parameters, a function of source wavelet and multi-component seismic records are taken as inputs, to solve the first order velocity-stress equation of an elastic isotropic medium by a staggered grid high-order finite difference method, thereby obtaining a source stress tensor wave field and a detected particle vibration velocity vector wave field;
a decoupled wave equation solving unit 1002 for constructing a decoupled wave equation by using the detected particle vibration velocity vector wave field to obtain a decoupled detected longitudinal wave particle vibration velocity vector wave field and a decoupled detected transverse wave particle vibration velocity vector wave field;
a decoupled pseudo-stress equation solving unit 1003 for constructing a decoupled pseudo-stress equation by using the decoupled detected longitudinal wave particle vibration velocity vector wave field and the decoupled detected transverse wave particle vibration velocity vector wave field to obtain a detected decoupled pseudo-stress tensor wave field;
an imaging result calculation unit 1004 for calculates the source stress tensor wave field and the detected decoupled pseudo-stress tensor wave field by using a double-dot product cross-correlation imaging condition algorithm, to obtain a pseudo PP scalar imaging result and a pseudo PS scalar imaging result, and taking the pseudo PP scalar imaging result and the pseudo PS scalar imaging result as elastic wave stress tensor double-dot product seismic imaging results.

Since the principle of solving the problem by the above device is similar to that of the above method, the implementation of the above device can refer to the implementation of the above method, and the repeated parts will not be described again.

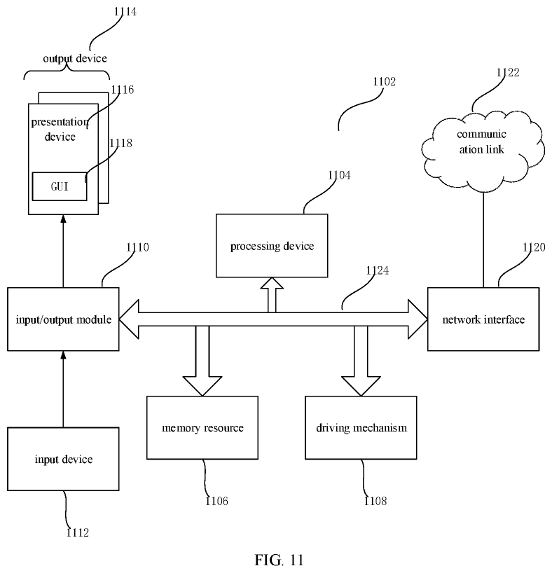

It should be noted that the above device can be applied to physical computer device, and corresponding codes are written according to the units in the device, that is, the above method is described using the codes. Specifically, FIG. 11 is a structural schematic diagram of a computer device according to an embodiment of the present specification. A processing unit (such as a CPU or the like) of the computer device in the embodiment of the present disclosure is capable of executing the method of the embodiment of the present disclosure described above. The computer device 1102 may include one or more processing devices 1104, such as one or more central processing units (CPUs), each of which may implement one or more hardware threads. The computer device 1102 may also include any memory resource 1106 for storing any kind of information, such as codes, settings, data, or the like. By way of non-limiting examples, the memory resource 1106 may include any one or more of the following: any type of RAM, any type of ROM, a flash device, a hard disk, an optical disk, or the like. More generally, any memory resource may use any technique to store information. Further, any memory resource may provide a volatile or non-volatile retention of information. Further, any memory resource may represent a stationary or removable component of the computer device 1102. In one case, when the processing device 1104 executes associated instructions stored in any memory resource or combination of the memory resources, the computer device 102 may perform any of the operations of the associated instructions. The computer device 1102 also includes one or more driving mechanisms 1108 for interacting with any memory resource, such as a hard disk driving mechanism, an optical disc driving mechanism or the like.

The computer device 1102 may also include an input/output module 1110 (I/O) for receiving various inputs (via the input device 1112) and for providing various outputs (via the output device 1114). One particular output mechanism may include a presentation device 1116 and an associated graphical user interface (GUI) 1118. In other embodiments, the input/output module 1110 (I/O), the input device 1112, and the output device 1114 may also be excluded, as just one computer device in the network. The computer device 1102 may also include one or more network interfaces 1120 for exchanging data with other devices via one or more communication links 1122. One or more communication buses 1124 couple the components described above together.

The communication link 1122 may be implemented in any manner, such as over a local area network, a wide area network (e.g., the Internet), a point-to-point connection, or the like, or any combination thereof The communication link 1122 may include any combination of hardwired links, wireless links, routers, gateway functions, name servers, etc., governed by any protocol or combination of protocols.

Corresponding to the method in FIG. 1, the embodiment of the present disclosure further provides a computer readable storage medium which stores a computer program that, when run by a processor, executes the above steps.

The embodiment of the present disclosure further provides computer readable instructions, wherein when the instructions are executed by the processor, the program therein causes the processor to execute the method shown in FIG. 1.

It is to be understood that in the various embodiments of the present specification, the serial numbers of the processes described above do not mean a sequential order of execution, the sequence in which the processes are executed should be determined in terms of th functions and inherent logic thereof, and should not constitute any limitation to the implementation process of the embodiment of the present specification.

What is claimed is:

1. An elastic wave stress tensor double-dot product seismic imaging method, wherein, comprising:
based on a first order velocity-stress equation of an elastic isotropic medium, medium model parameters, a function of source wavelet and multi-component seismic records are taken as inputs, to solve the first order velocity-stress equation of an elastic isotropic medium by a staggered grid high-order finite difference method, thereby obtaining a source stress tensor wave field and a detected particle vibration velocity vector wave field;
constructing a decoupled wave equation by using the detected particle vibration velocity vector wave field to obtain a decoupled detected longitudinal wave particle vibration velocity vector wave field and a decoupled detected transverse wave particle vibration velocity vector wave field;
constructing a decoupled pseudo-stress equation by using the decoupled detected longitudinal wave particle vibration velocity vector wave field and the decoupled detected transverse wave particle vibration velocity vector wave field to obtain a detected decoupled pseudo-stress tensor wave field;
the source stress tensor wave field and the detected decoupled pseudo-stress tensor wave field are calculated by using a double-dot product cross-correlation imaging condition algorithm to obtain a pseudo PP scalar imaging result and a pseudo PS scalar imaging result, and taking the pseudo PP scalar imaging result and the pseudo PS scalar imaging result as elastic wave stress tensor double-dot product seismic imaging results.

2. The method according to claim 1, wherein, the first order velocity-stress equation of an elastic isotropic medium is:
$$\{ \begin{matrix}\frac{\partial {τ}_{xx}}{\partial t} = ( λ + 2 μ ) \frac{\partial {v}_{x}}{\partial x} + λ \frac{\partial {v}_{z}}{\partial z} \\ \frac{\partial {τ}_{zz}}{\partial t} = λ \frac{\partial {v}_{x}}{\partial x} + ( λ + 2 μ ) \frac{\partial {v}_{z}}{\partial z} \\ \frac{\partial {τ}_{xz}}{\partial t} = μ \frac{\partial {v}_{z}}{\partial x} + μ \frac{\partial {v}_{x}}{\partial z} \\ ρ \frac{\partial {v}_{x}}{\partial t} = \frac{\partial {τ}_{xx}}{\partial x} + \frac{\partial {τ}_{xz}}{\partial z} \\ ρ \frac{\partial {v}_{z}}{\partial t} = \frac{\partial {τ}_{xz}}{\partial x} + \frac{\partial {τ}_{zz}}{\partial z}\end{matrix} ,$$
wherein (τₓₓ, τ_{zz}, τ_{xz}) denotes the source stress tensor wave field, (vₓ, v_{z}) denotes the detected particle vibration velocity vector wave field, A, and p denote Lame's parameters, ρ denotes density, t denotes time, x and z denote x and z directions of a two-dimensional Cartesian coordinate system respectively;
the grid points of the staggered grid are defined as (1:vₓ; 2:(τₓₓ, τ_{zz}; 3:τ_{xz}; 4:v_{z}), wherein 1, 2, 3 and 4 are four different spatial positions in the cells of the staggered grid.

3. The method according to claim 2, wherein, based on a first order velocity-stress equation of an elastic isotropic medium, medium model parameters, a source function of wavelet and multi-component seismic records are taken as inputs, to solve the first order velocity-stress equation of an elastic isotropic medium by a staggered grid high-order finite difference method, thereby obtaining a source stress tensor wave field and a detected particle vibration velocity vector wave field, further includes:
based on the definition of the grid points, the staggered grid high-order finite difference method is used to discretize the first order velocity-stress equation of an elastic isotropic medium, and a discrete scheme is given as follows:
$${v}_{{x}_{i + \frac{1}{2} , k}}^{n + \frac{1}{2}} = {v}_{{x}_{i + \frac{1}{2} , k}}^{n - 1 \frac{1}{2}} + {ρ}^{- 1} \cdot Δ t \cdot {F}_{x} {τ}_{{xx}_{i , k}}^{n} + {ρ}^{- 1} \cdot Δ t \cdot {B}_{z} {τ}_{{xz}_{i + \frac{1}{2} , k + \frac{1}{2}}}^{n} \\ {v}_{{z}_{i , k + \frac{1}{2}}}^{n + \frac{1}{2}} = {v}_{{z}_{i , k + \frac{1}{2}}}^{n - 1 \frac{1}{2}} + {ρ}^{- 1} \cdot Δ t \cdot {B}_{x} {τ}_{{xz}_{i + \frac{1}{2} , k + 1 \frac{1}{2}}}^{n} + {ρ}^{- 1} \cdot Δ t \cdot {F}_{x} {τ}_{{zz}_{i , k}}^{n} \\ {τ}_{{xx}_{i , k}}^{n} = {τ}_{{xx}_{i , k}}^{n - 1} + Δ t ( λ + 2 μ ) {B}_{x} {v}_{{x}_{i + \frac{1}{2} , k}}^{n + \frac{1}{2}} + Δ t λ {B}_{z} {v}_{{z}_{i , k + \frac{1}{2}}}^{n + \frac{1}{2}} , \\ {τ}_{{zz}_{i , k}}^{n} = {τ}_{{zz}_{i , k}}^{n - 1} + Δ t \cdot λ \cdot {B}_{x} {v}_{{x}_{i + \frac{1}{2} , k}}^{n + \frac{1}{2}} + Δ t \cdot ( λ + 2 μ ) {B}_{z} {v}_{{z}_{i , k + \frac{1}{2}}}^{n + \frac{1}{2}} \\ {τ}_{{xz}_{i + \frac{1}{2} , k + \frac{1}{2}}}^{n} = {τ}_{{xz}_{i + \frac{1}{2} , k + \frac{1}{2}}}^{n - 1} + Δ t \cdot μ {F}_{x} {v}_{{z}_{i , k + \frac{1}{2}}}^{n + \frac{1}{2}} + Δ t \cdot μ {F}_{z} {v}_{{x}_{i + \frac{1}{2} , k}}^{n + \frac{1}{2}}$$
wherein Δt denotes time interval, i and k denote discrete points in the x and z directions in the two-dimensional Cartesian coordinate system respectively, n denotes discrete point in the direction of time t, ρ⁻¹ denotes the −1 power of the density ρ, F,(s=x, z) and Bₛ (s=x, z) denote a forward difference operator and a backward difference operator in x, z directions respectively, and the specific expression is as follows:
$${F}_{x} {f}_{i , k} = \frac{1}{Δ x} {\sum }_{m = 1}^{M} {c}_{m}^{( M )} [ {f}_{i + m , k} - {f}_{i - m + 1 , k} ] , \\ {B}_{x} {f}_{i , k} = \frac{1}{Δ x} {\sum }_{m = 1}^{M} {c}_{m}^{( M )} [ {f}_{i + m - 1 , k} - {f}_{i - m , k} ] , \\ {F}_{z} {f}_{i , k} = \frac{1}{Δ z} {\sum }_{m = 1}^{M} {c}_{m}^{( M )} [ {f}_{i , k + m} - {f}_{i , k - m + 1} ] , \\ {B}_{z} {f}_{i , k} = \frac{1}{Δ z} {\sum }_{m = 1}^{M} {c}_{m}^{( M )} [ {f}_{i , k + m - 1} - {f}_{i , k - m} ] .$$
wherein Δr and Δz denote sampling intervals in x and z directions respectively, f_{i,k} denotes a wave field quantity acted by difference operator, i and k denote the discrete points and are used for determining the spatial location of the wave field quantity, Cₘ^{(M)} (denotes finite difference coefficients of the 2M-order staggered grid, 2 M denotes difference order, and M denotes a positive integer;
the Lame's parameters λ and μ, and the density ρ are obtained according to the given medium model parameters by using the discrete scheme;
a P-wave source in the form of a Ricker wavelet which loaded during extension process of a source wave field is loaded on (τₓₓ, τ_{zz}) of the source stress tensor wave field, to obtain the source stress tensor wave field (τₓₓ, τ_{zz}, τ_{xz});
multi-component seismic records during extension process of the detected wave field is loaded on the detected particle vibration velocity vector wave field (vₓ, v_{z}), to calculate and obtain the detected particle vibration velocity vector wave field (vₓ, v_{z})

4. The method according to claim 3, wherein, constructing a decoupled wave equation by using the detected particle vibration velocity vector wave field to obtain a decoupled detected longitudinal wave particle vibration velocity vector wave field and a decoupled detected transverse wave particle vibration velocity vector wave field, further includes:
the decoupled wave equation is as follows,
$$\frac{\partial {τ}^{P}}{\partial t} = ( λ + 2 μ ) ( \frac{\partial {v}_{x}}{\partial x} + \frac{\partial {v}_{z}}{\partial z} ) ,$$
wherein τ^{P} denotes the auxiliary P-wave stress;
the decoupled detected longitudinal wave particle vibration velocity vector wave field is as follows,
$$\{ \begin{matrix}ρ \frac{\partial {v}_{x}^{P}}{\partial t} = \frac{\partial {τ}^{P}}{\partial x} \\ ρ \frac{\partial {v}_{z}^{P}}{\partial t} = \frac{\partial {τ}^{P}}{\partial z}\end{matrix} ,$$
Wherein, (vₓ^{P}, v_{z}^{P}) denotes the decoupled detected longitudinal wave particle vibration velocity vector wave field;
the decoupled detected transverse wave particle vibration velocity vector wave field is as follows,
$$\{ \begin{matrix}{v}_{x}^{S} = {v}_{x} - {v}_{x}^{P} \\ {v}_{z}^{S} = {v}_{z} - {v}_{z}^{P}\end{matrix} ,$$
Wherein, (vₓ^{S}, v_{z}^{S}) denotes the decoupled detected transverse wave particle vibration velocity vector wave field.

5. The method according to claim 4, wherein, constructing a decoupled pseudo-stress equation by using the decoupled detected longitudinal wave particle vibration velocity vector wave field and the decoupled detected transverse wave particle vibration velocity vector wave field to obtain a detected decoupled pseudo-stress tensor wave field, further includes:
the decoupled pseudo-stress equation includes a longitudinal wave pseudo-stress equation and a transverse wave pseudo-stress equation, wherein the longitudinal wave pseudo-stress equation is as follows:
$$\{ \begin{matrix}\frac{\partial {τ}_{xx}^{qP}}{\partial t} = ( λ + 2 μ ) ( \frac{\partial {v}_{x}^{P}}{\partial x} + \frac{\partial {v}_{x}^{P}}{\partial z} ) - 2 μ \frac{\partial {v}_{z}^{P}}{\partial z} \\ \frac{\partial {τ}_{zz}^{qP}}{\partial t} = ( λ + 2 μ ) ( \frac{\partial {v}_{x}^{P}}{\partial x} + \frac{\partial {v}_{x}^{P}}{\partial z} ) - 2 μ \frac{\partial {v}_{x}^{P}}{\partial x} \\ \frac{\partial {τ}_{xz}^{qP}}{\partial t} = μ ( \frac{\partial {v}_{x}^{P}}{\partial z} + \frac{\partial {v}_{z}^{P}}{\partial x} )\end{matrix}$$
wherein (τₓₓ^{qP}, τ_{zz}^{qP}, τ_{xz}^{qP}) denotes a longitudinal wave pseudo stress;
the transverse wave pseudo-stress equation is as follows,
$$\{ \begin{matrix}\frac{\partial {τ}_{xx}^{qS}}{\partial t} = - 2 μ \frac{\partial {v}_{z}^{S}}{\partial z} \\ \frac{\partial {τ}_{zz}^{qS}}{\partial t} = - 2 μ \frac{\partial {v}_{x}^{S}}{\partial x} \\ \frac{\partial {τ}_{xz}^{qS}}{\partial t} = μ ( \frac{\partial {v}_{x}^{S}}{\partial z} + \frac{\partial {v}_{z}^{S}}{\partial x} )\end{matrix}$$
wherein (τₓₓ^{qS}, τ_{zz}^{qS}, τ_{xz}^{qS}) denotes a transverse wave pseudo stress;
the decoupled detected longitudinal wave particle vibration velocity vector wave field (vₓ^{P}, v_{z}^{P}) and the decoupled detected transverse wave particle vibration velocity vector wave field (vₓ^{S}, v_{z}^{S}) are substituted into the longitudinal wave pseudo-stress equation and the transverse wave pseudo-stress equation respectively to obtain the detected decoupled pseudo-stress tensor wave field Rcv, wherein the detected decoupled pseudo-stress tensor wave field includes a detected longitudinal wave decoupled pseudo-stress tensor wave field Rcv^{P}=(τₓₓ^{qP}, τ_{zz}^{qP}, τ_{xz}^{qP}) and a detected transverse wave decoupled pseudo-stress tensor wave field Rcv^{S}=(τₓₓ^{qS}, τ_{zz}^{qS}, τ_{xz}^{qS}) .

6. The method according to claim 5, wherein, the source stress tensor wave field and the detected decoupled pseudo-stress tensor wave field are calculated by using a double-dot product cross-correlation imaging condition algorithm to obtain a pseudo PP scalar imaging result and a pseudo PS scalar imaging result, further includes,
the source stress tensor wave field Src=(τₓₓ, τ_{zz}, τ_{xz}) and the detected decoupled pseudo-stress tensor wave field Rcv are calculated by using a double-dot product cross-correlation imaging condition algorithm:
$$\{ \begin{matrix}{I}_{qPP} = {\int }_{0}^{{t}_{max}} ( {Src}_{{σ}_{xx}} ( x , t ) {Rcv}_{{τ}_{xx}^{qP}}^{P} ( x , t ) + {Src}_{{σ}_{zz}} ( x , t ) {Rcv}_{{τ}_{zz}^{qP}}^{P} ( x , t ) + 2 {Src}_{{σ}_{xz}} ( x , t ) {Rcv}_{{τ}_{xz}^{qP}}^{P} ( x , t ) ) dt \\ {I}_{qPS} = {\int }_{0}^{{t}_{max}} ( {Src}_{{σ}_{xx}} ( x , t ) {Rcv}_{{τ}_{xx}^{qS}}^{S} ( x , t ) + {Src}_{{σ}_{zz}} ( x , t ) {Rcv}_{{τ}_{zz}^{qS}}^{S} ( x , t ) + 2 {Src}_{{σ}_{xz}} ( x , t ) {Rcv}_{{τ}_{xz}^{qS}}^{S} ( x , t ) ) dt\end{matrix} ,$$
calculating to obtain the pseudo PP scalar imaging result and the pseudo PS scalar imaging result, wherein I_{qPP} denotes the pseudo PP scalar imaging result I_{qPS} denotes the pseudo PS scalar imaging result, x denotes spatial position, t denotes time; Src and Rcv denote corresponding component forms of the source stress tensor wave field Src and the detected decoupled pseudo-stress tensor wave field Rcv respectively.

7. A computer device comprising a memory, a processor and a computer program stored on the memory and executable on the processor, wherein, when executing the computer program, the processor implements the method of claim 1.

8. A computer-readable storage medium, wherein, the computer-readable storage medium stores a computer program which, when executed by a processor, implements the method of claim 1.
